(19) United States
(12) Patent Application Publication
(10) Pub. No.: US 2017/0178528 A1
(43) Pub. Date: Jun. 22, 2017

(54) Method and System for Providing Automated Localized Feedback for an Extracted Component of an Electronic Document File

(71) Applicant: TURNITIN, LLC, Oakland, CA (US)

(72) Inventors: Elijah Jacob Mayfield, Pittsburgh, PA (US); Stephanie E. Butler, Pittsburgh, PA (US); David S. Adamson, Pittsburgh, PA (US)

(21) Appl. No.: 14/971,637

(22) Filed: Dec. 16, 2015

(51) Int. Cl. G09B 7/02; G06F 17/24; G06F 17/27

(52) U.S. Cl. CPC G09B 7/02; G06F 17/2705; G06F 17/241

(57) ABSTRACT

A computer-implemented system automatically analyzes an electronic document that is a representation of an essay, and it automatically generates localized feedback for specific text spans within the essay. The localized feedback relates to the text span's impact on the overall quality of the essay. The system does this by generating scores for the essay both with and without the text span, and determining an impact value representing the difference between the probable scores. The system then uses the impact value to identify a comment that is appropriate for the text span's impact value.

### BACKGROUND

The grading of written work product, such as student essays, is a time-intensive and labor-intensive process. To address this problem, several systems have been proposed to perform automated essay scoring. However, these systems merely provide the student with a score, and they do not include tools to help the student improve. While a score can help a student understand whether or not he or she needs to improve work product, it does not help the student understand specifically what or why he or she needs to improve.

This system describes methods and systems for automatically providing localized feedback on essays.

### SUMMARY

In an embodiment, a system that generates localized feedback for an electronic representation of an essay receives an electronic document file that includes an electronic representation of text from a candidate essay, processes the document file to analyze the candidate essay and generate a score for the candidate essay, and parses the document file to identify and extract text spans in the candidate essay. For at least one of the identified text spans, the system may generate a revised essay that omits the identified text span, analyze the revised essay, and generate a score for the revised essay. The system may determine an impact value for the identified text span so that the impact value represents a measure of difference between the score for the candidate essay and the score for the revised essay. The system will access a data set of candidate comment and select, from the data set based on at least the impact value, a comment that is associated with the essay and/or text span type. The system may generate a revised document file that includes a text representation of the candidate essay, along with the selected comment in association with the identified text span. The system may then cause a document presentation device to output the candidate essay with a comment that corresponds to the selected feedback in association with the identified text span.

Optionally, when analyzing the candidate essay and generating the score for the candidate essay, the system may: (i) extract a set of feature values from the candidate essay; (ii) access a scoring model that includes probabilities that various feature values will be associated with various human-generated scores for a set of additional essays, wherein the candidate essay and each of the additional essays are responsive to a common prompt; and (iii) apply the scoring model to the feature values extracted from the candidate essay to determine the score for the candidate essay. When analyzing the revised essay and generating the score for the revised essay the system may extract a set of feature values from the revised essay and apply the scoring model to the feature values extracted from the revised essay to determine the score for the revised essay.

Optionally, when parsing the document file to identify and extracting the text spans in the candidate essay, the system may process the candidate essay to identify one or more sequences of characters that correspond to the structure of a single sentence, and it may identify each text span so that each text span is a single sentence of the candidate essay.

In some embodiments, to select the comment the system may select, from the data set, a comment that is tagged with a value that corresponds to the determined impact value. Alternatively or in addition, the system may identify a set of candidate comments that correspond to a type of the essay, apply one or more rules to filter the set of candidate comments, and select the comment from the candidate comments that remain after the filtering.

When generating the revised document file that includes the text representation of the candidate essay along with the selected comment, the system may identify a set of candidate comments that correspond to a type of the essay, generate a priority value for each of the candidate comments, and automatically populate a comment box with those candidate comments whose priority value is at least equal to a threshold value.

Optionally, the document presentation device may output the candidate essay with the comment displayed in the candidate essay as an annotation to the identified text span.

In some embodiments, the system also may: (i) identify a first descriptor for the essay and a second descriptor for the identified text span; (ii) access an essay library via a computer network; (iii) select, from the essay library, an essay from the library, in which the essay has a descriptor that corresponds to the first descriptor; (iv) identify, within the selected essay, a replacement text span having a descriptor that corresponds to the second descriptor; (v) extract the replacement text span from the essay library; (vi) replace the identified text span with the replacement text span; and (vii) cause the document presentation device to output the candidate essay with the replacement text span presented in place of the identified text span.

In other embodiments, the system may: (i) perform an automated transformation process on the identified text span to yield a mutated text span by replacing one or more words in the identified text spans with a synonym, or by changing an order of clauses within the identified span; (ii) analyze the essay with the mutated text span and generate a second score for the revised essay with the mutated text span; and (iii) determine whether the mutated text span has a positive or negative impact on the score of the essay.

### BRIEF DESCRIPTION OF THE DRAWINGS

FIG. 1 is a flow diagram illustrating an example of a system for automatically analyzing the impact of a text span on the score of a document that contains the text span.

FIG. 2 is a flow chart illustrating various steps in a process for analyzing the impact of an extracted text span on the score of a document that contains the text span.

FIG. 3 illustrates an example of a comment generation process.

FIG. 4 illustrates an example of an annotated document that the system may produce.

FIG. 5 illustrates an example of various hardware elements that may be used in the embodiments of this disclosure.

### DETAILED DESCRIPTION

In this document, the singular forms “a,” “an,” and “the” include plural references unless the context clearly dictates otherwise. The term “comprising” means “including, but not limited to.” Unless defined otherwise, all technical and scientific terms used in this disclosure have the same meanings as commonly understood by one of ordinary skill in the art. In addition, when used in this disclosure, the following words have the following meanings:

The term “extract” means electronically analyze and select a discrete set of content elements within an electronic document, and storing the selected set of content elements in a temporary or long-term memory device for analysis or other processing.

An “image capturing device” or “imaging device” refers to any device having one or more image sensors capable of optically viewing an object, and components that are configured to convert an interpretation of that object into an electronic data file. One such example of an imaging device is a digital camera, another is a document scanner.

The term “multifunction print device” refers to a machine having hardware and associated software configured to enable the device to print documents on substrates, as well as perform at least one other function such as copying, facsimile transmitting or receiving, image scanning, or performing other actions on document-based data.

The term “score” means a measured assessment of the quality of an item such as an essay. A score may be a numeric score (such as on a scale of 0 to 10, or a scale of 0 to 100), a letter grade (such as A, B, C), a word that reflects a measure of quality (such as “pass” or “fail”); or another measure of quality.

A “text span” is a discrete set of sequentially-occurring text elements within an electronic document. Examples of text spans may be a sentence, a group of consecutive sentences, a clause within a sentence, a paragraph or group of consecutive paragraphs, or another contiguous text structure.

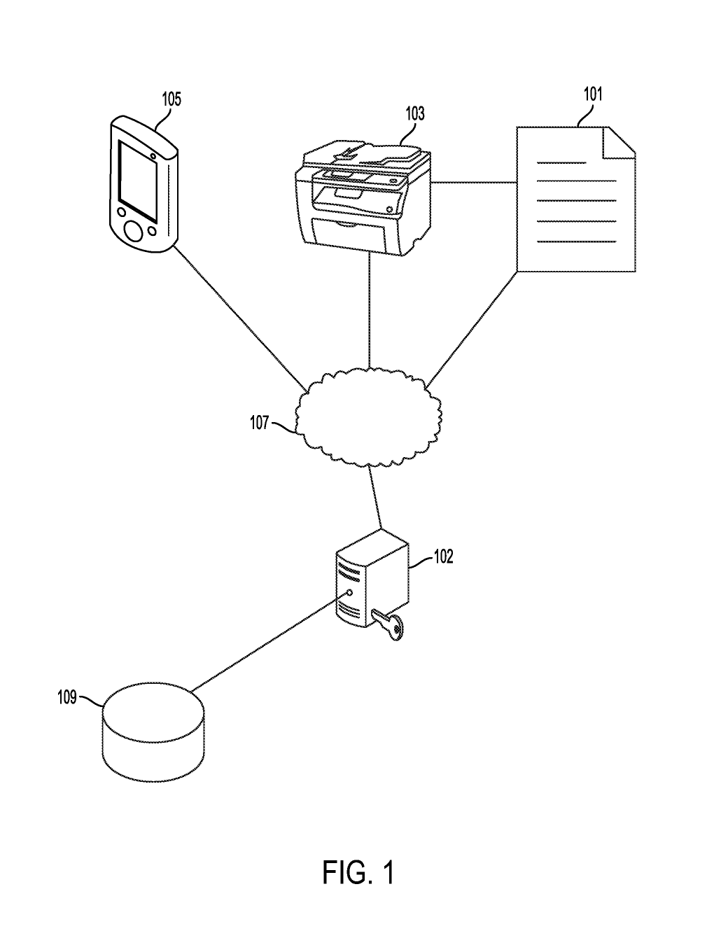

FIG. 1 illustrates various elements of a system for automatically analyzing an electronic representation of an essay and providing localized feedback on one or more text spans within the essay. The system receives an electronic file that includes the text of a candidate essay document 101 in electronic form. The system's local or cloud-based server 102 may receive the document file via a communications network 107 such as the Internet, a local area network, a Wi-Fi network, or a network made of the server and one or more wirelessly-connected devices using a near-field or other short-range communication protocol. Alternatively, an electronic device containing image capture hardware, such as the scanner of a multi-function print device 103 or the camera of a user electronic device 105 may scan or capture an image of the document and use one or more now or hereafter known image processing protocols to convert text of the essay into the electronic file. In addition, the user electronic device 105 may include or have access to word processing software and a user interface (such as a keyboard and/or touch screen) by which the system will receive the essay as generated via the user interface. The system may store the document file, either temporarily or for a longer period of time, in a computer-readable memory component of any of the devices in the system.

The server 102 will contain a processing device, and it will include or have access to a computer-readable memory device containing programming instructions that enable the server 102 to perform some or all of the actions described in this document. The user's electronic device 105 also will contain a processing device, and it will include or have access to a computer-readable memory device containing programming instructions that enable the electronic device 105 to perform some or all of the actions described in this document. The print device 102 and electronic device 105 also may serve as document generation devices, as will be described in more detail below.

The server 102 also may be able to access a data storage facility 109 using one or more communications links such as those described above. The data storage facility 109 may store a data set of candidate comments for use when providing feedback, as well as other data. In addition, data and programming instructions that the system uses to perform the methods described below may be stored on computer-readable media contained within the data storage facility 109 and/or combination of the data storage facility with other devices shown in FIG. 1, and/or other devices.

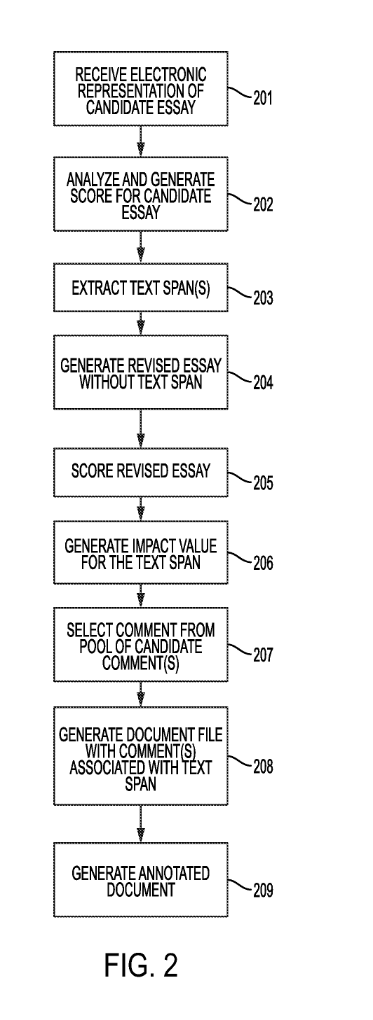

FIG. 2 is a flow diagram illustrating a process of generating localized feedback for an electronic representation of an essay. The system will receive an electronic document file (step 201) that includes an electronic representation of text from a candidate essay. As described above, the system may receive this file in electronic form from another electronic device as transmitted to the system via a communications network, or the system may use an image capturing device to scan or otherwise capture an image of a printed version of the essay and convert the image to an electronic file that contains the text and structure (e.g., punctuation, formatting, etc.) of the essay. Or, the system may include or have access to word processing software so that system can receive the essay as generated via a user interface of an electronic device that is running the word processing software.

The system will process the document file to analyze the candidate essay and generate a score for the candidate essay (step 202). The system may do this using any suitable scoring process, such as a text-based classifier whose output includes a discrete score (such as a letter grade—A, B, C, D, etc.—or a numerical score) and/or a probability distribution across possible scores (e.g., {A: 20%, B: 60%, C: 10%, D: 5%, F: 5%} for each classified essay. Another example of a suitable classifier is disclosed in U.S. Patent Application Pub. No. 2015/0199913, filed by inventors Mayfield and Adamson, the disclosure of which is incorporated herein by reference in full. Such a system may extract a set of feature values from the candidate essay; access a scoring model that includes probabilities that various feature values will be associated with various human-generated scores for a set of additional essays, wherein the candidate essay and each of the additional essays are responsive to a common prompt; and apply the scoring model to the feature values extracted from the candidate essay to determine the score for the candidate essay.

The system will also parse the document file to identify and extract a set of one or more text spans in the candidate essay (step 203). The system may do this by executing an image processing function to recognize a set of characters in an electronic image, or by executing a text analysis function to recognize a set of characters in a text-based file that correspond to a text span. For example, the system may consider a first set of sequentially-occurring text elements that ends in a period to be a sentence, and it may consider each next-occurring set of sequentially-occurring text elements that ends in a period within the document also to be a sentence. The system may group two or more sentences into a text span. The system may compare content of a sentence to a taxonomy of sentence structures and use the taxonomy and/or certain punctuation marks (such as commas) to identify clauses within a sentence. Or, the system may identify formatting elements (such as blank spaces of at least a threshold size appearing before and/or after a set of one or more sentences) to indicate that the text within the blank spaces is a text span that corresponds to a paragraph. The system may similarly group two or more sequentially-occurring paragraphs, sentence clauses, or other document fragments of sequentially occurring text, to be a text span.

For at least one of the identified text spans, the system will generate a revised essay that omits the identified text span (step 204) but which retains the other text-based content elements of the original candidate essay. It may store the revised essay as a data file in electronic form, and it will analyze the revised essay and generate a score for the revised essay (step 205) using scoring methods such as those described above. As with the original score for the candidate essay, the revised score may be a single value or a probability distribution across multiple possible scores. For example, the system may analyze the revised essay by extracting a set of feature values from the revised essay, and applying the scoring model to the feature values extracted from the revised essay to determine the score for the revised essay using procedures such as those described above.

The system will determine an impact value (step 206) for the identified text span so that the impact value comprises a measure of difference between the score for the candidate essay and the score for the revised essay. The measure may be as simple as an absolute value of the actual difference (i.e., |candidate essay score−revised essay score|), or it may be a more complex function such as: (i) one that applies more or less weight to the candidate essay or the revised essay; (ii) one that compares functions of probability distributions of possible scores for the candidate essay and the revised essay; and/or (iii) one that incorporates other factors such as a size of the text span (e.g., number of character in it), a category of the text span (e.g., sentence, paragraph, etc.).

For each possible score of a candidate or revised essay, the system may determine a mean and standard deviation of a set of variant essay likelihood. The system may then standardize the likelihood of each variant essay by subtracting the mean and dividing the result by the standardized deviation. The standardized value may be considered to be the impact value, representing a measure of the impact of removing the text span on the essay's score.

For any given text span in an essay, a greater-magnitude negative impact value may imply that the removal of a span decreased the likelihood that the candidate essay's score would still occur if the span were removed. Thus, such a span may contribute a greater amount toward the score than most other text spans in the candidate essay. On the other hand, a text span with a lesser-magnitude positive impact value may indicate that deletion of the text span resulted in a greater likelihood that the candidate essay's score would occur. Such a span may thus be considered less relevant to (i.e., less impactful on) the candidate essay's score than most other text spans in the candidate essay.

The positive or negative impact value described above, and particular the relative magnitude of the value, may be considered to be the “valence” of a text span. The system may use the valence of a text span when generating comments, as will be described in more detail below.

The system will then access a data set of candidate comments and select, from the data set based on at least the impact value, a comment for the text span from the set of candidate comments (step 207). To identify the proper comment from the data set, the system may select a comment that is tagged (i.e., associated with, through the use of metadata or another indicator of association) with a value that corresponds to the determined impact value. Other metadata that may be associated with candidate comments (and used for selection) include type of essay (e.g., “9th-10th Grade Persuasive Essay”), the nature of the trait for which the impact value was determined (e.g., “Development of Ideas”). The system may also consider factors such as the original essay's score and the span's valence when selecting a candidate comment.

Optionally, a candidate essay may have more than one score. For example, a candidate essay may receive a score for each of various traits, such as: (i) analysis and organization; (ii) language and genre awareness; (iii) use of evidence; and (iv) clarity and focus. If so, then the process of extracting text spans, scoring the resulting revised essays and generating impact values for each text span may be performed for each such trait-based score.

In addition to the process described above, or as a variation of it, the system may generate one or more variant essays that replace or alter one or more extracted and removed text spans. For example, the system may replace the extracted text spans with text spans from a similar essay. To do this, the system would have access via a local or remote communication network to a data storage facility containing an essay library. Each essay in the library is associated with one or more descriptors (such as type or topic). Each essay in the library would also include text spans that are also associated with one or more descriptors. The system would use these descriptors to select an essay from the library having a descriptor that corresponds to (i.e., matches, is synonymous with, or is complementary to) the current essay. It would also identify an embedded text span within the selected essay having a descriptor that corresponds to a descriptor of the current text span that is to be replaced.

As another example, the system may generate a new text span by an automated transformation process, such as one that replaces one or more verbs (or other parts of speech) in a text span with certain synonyms, or one that changes the order of clauses within a text span. The system may consider this essay with the altered or replaced text span to be the revised essay, and it may perform its scoring accordingly.

Following a mutation process such as that described above, the system may interpret negative impact values similarly to those applied to the “pure” removal process (i.e., removal without replacement). If so, then if a mutation in a given text span has negative impact value and thus decreases the likelihood of a particular score, the system may consider the original text span to be a stronger indicator of the score than the mutated alternative. Conversely, a mutation that has a positive impact value would indicate that the mutation increases the likelihood of a particular score.

The system will then generate a revised document file (step 208) that includes a text representation of the candidate essay, along with the selected comment in association with the identified text span. The system may use a feedback template or other structure to apply the comment to the document in association with a particular text span. If multiple text spans have been analyzed and are candidates for comments, the system may implement any suitable rule to determine which text span(s) that will receive comments. For example, the system may identify relatively “strong” text spans and relatively “weak” text spans based on automated analysis ad scoring of text within the text span, user feedback associated with the span, or other criteria. A relatively “strong” span is one that increases the likelihood of a more desirable (i.e., higher) score than the candidate essay's calculated score. A relatively “weak” span will be one that increases the likelihood of a less desirable (i.e., lower) score. Optionally, spans must have at least a threshold valence (i.e., level of impact on the essay's score) in order to receive a comment at all. Optionally, the rules may require that there be no more than a threshold number of comments for every n text spans of the essay.

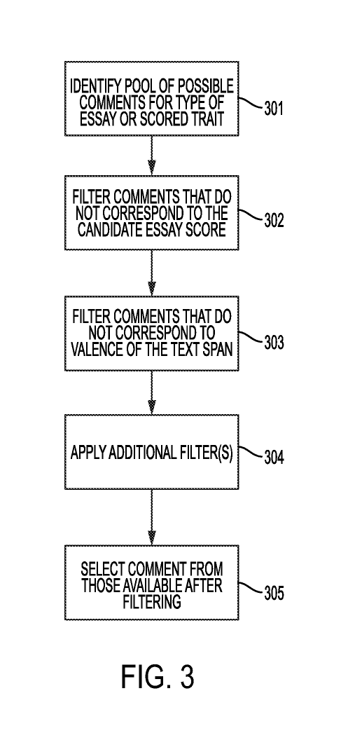

FIG. 3 describes an example process of how the system may select a comment for a text span. For example, the system may access a data storage facility with the candidate and identify all possible comments that are appropriate for the type of essay and/or the type of scored trait (step 301). Optionally, each comment may have metadata that the system can use to filter out (i.e., not use) potential comments that are not relevant to the particular essay or text span. For example, a comment may be associated with a score or range of scores, and the system may filter out comments that are not associated with the candidate (original) essay's score (step 302). A comment may be associated with a valence or a range of valences, and the system may optionally filter out comments that are not associated with the text span's valence (step 303), which may be identified as described above. The system also may optionally apply one or more additional filtering rules (step 304) such as a scoring rule to remove additional comments until a single comment or a smaller group of comments remains. For example, if the system identifies that the text span corresponds to the essay's thesis statement or conclusion, the rules may require that the comment relate to a thesis statement or conclusion. As another example, if the system identifies that the text span includes a citation to source, or that the essay is in response to a specific task, the rules may require that the comment relate to the citation, source or task. The rules also may require that the comment correspond to a measured length (i.e., number of words or characters) in the text span. The system may assign priority values to the potential comments so that the priority value is a function of whether the potential comment satisfies each of the possible rules.

The system will then select one or more comments from the remaining pool of comments (step 305), either randomly or in association with one or more rules (such as by selecting the one(s) with the highest priority value), and it will place the comment(s) in the document in association with the text span. For example, the system may include rules configured to cause the system to select only the N-highest-impact comments per scored trait; to ensure that there are a relatively similar (i.e., balanced) number of positive/negative, strong/weak, or critical/suggestive comments; to ensure that a comment is not repeated within the essay or within multiple revisions of an essay; or configured to implement other constraints.

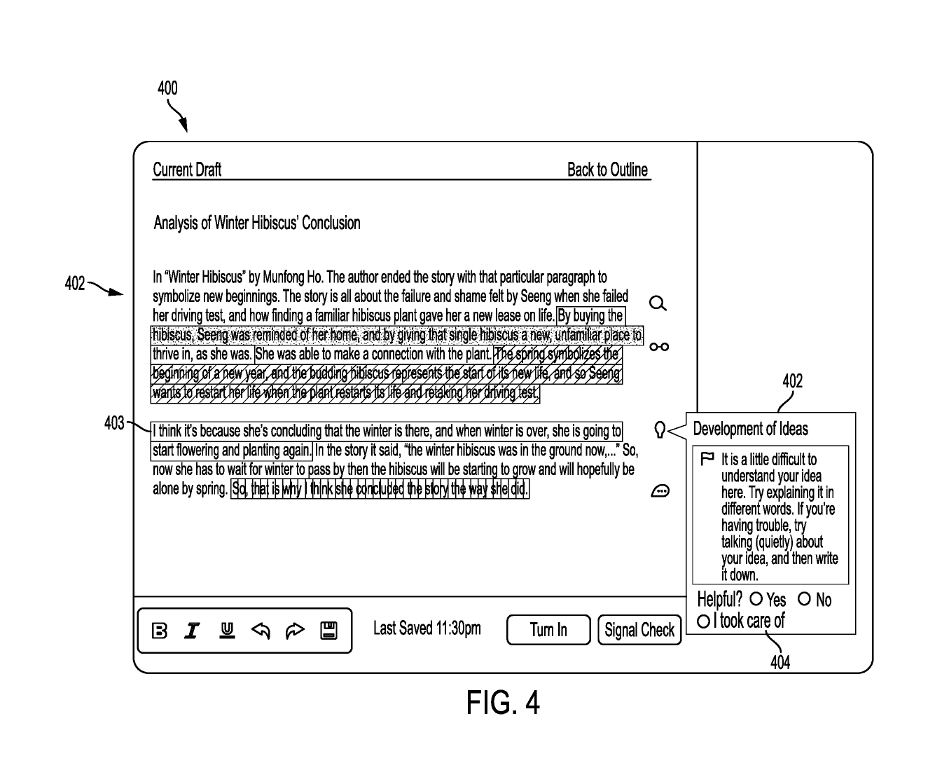

Returning to FIG. 2, the system will also cause a document presentation device to output the candidate essay (step 209) with the selected comment presented as an annotation that provides feedback in association with the identified text span. An example of such a document 400 is shown in FIG. 4. In FIG. 4, an essay 401 is displayed with a comment box 402 that provides the feedback in a sector of the display that includes a pointer to the identified text span 403, which is highlighted. The comment box also may include a reply field 404 which accepts input from the user in response to the comment. When a user enters data into or otherwise selects the reply field 404, the system may cause the display device to change so that the relevant comment box 402 is removed from the display. The document presentation device may be a display of the user electronic device, a document printing device such as the multifunctional printer of FIG. 1, or another device capable of receiving an electronic document file and outputting it in a form so that it may be read by a human user.

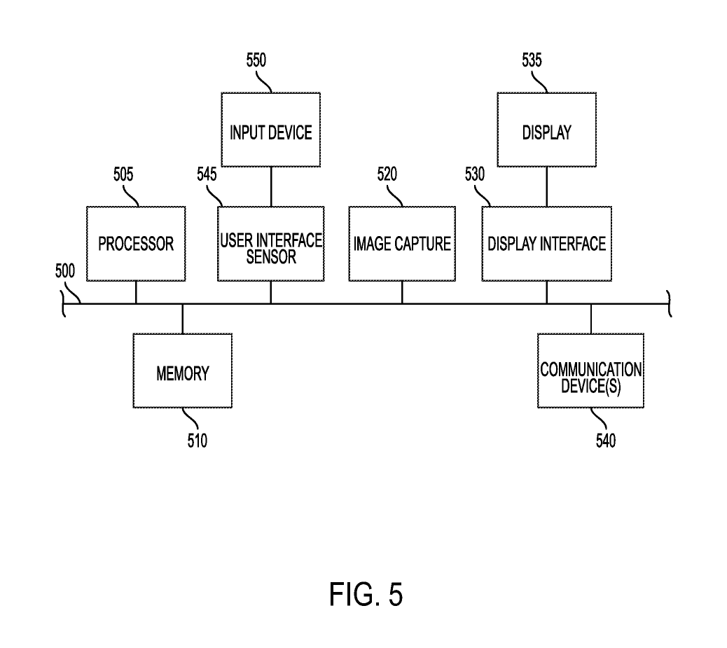

FIG. 5 depicts an example of internal hardware that may be included in any of the electronic components of the system, such as the user electronic device, or the remote server. An electrical bus 500 serves as an information highway interconnecting the other illustrated components of the hardware. Processor 505 is a central processing device of the system, configured to perform calculations and logic operations required to execute programming instructions. As used in this document and in the claims, the terms “processor” and “processing device” may refer to a single processor or any number of processors in a set of processors that together perform a function or group of functions. Read only memory (ROM), random access memory (RAM), flash memory, hard drives and other devices capable of storing electronic data constitute examples of memory devices 510. A memory device may include a single device or a collection of devices across which data and/or instructions are stored.

An optional display interface 530 may permit information from the bus 500 to be displayed on a display device 545 in visual, graphic or alphanumeric format. An audio interface and audio output (such as a speaker) also may be provided. Communication with external devices may occur using various communication devices 540 such as a transmitter and/or receiver, antenna, an RFID tag and/or short-range or near-field communication circuitry. A communication device 540 may be attached to a communications network, such as the Internet, a local area network or a cellular telephone data network.

The hardware may also include a user interface sensor 545 that allows for receipt of data from input devices 550 such as a keyboard, a mouse, a joystick, a touchscreen, a remote control, a pointing device, a video input device and/or an audio input device. The electronic representation of the essay and/or other data also may be received from an imaging capturing device 650 such of a scanner or camera.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A computer-implemented method of generating localized feedback for an electronic representation of an essay comprising:
by a processing device:
receiving an electronic document file, the file comprising an electronic representation of text from a candidate essay for evaluation;
processing the electronic document file to analyze the candidate essay and generate a score for the candidate essay;
parsing the electronic document file to identify and extract a plurality of text spans in the candidate essay; and
for at least one of the identified text spans:
generating a revised essay that omits the identified text span,
analyzing the revised essay and generating a score for the revised essay,
determining an impact value for the identified text span so that the impact value comprises a measure of difference between the score for the candidate essay and the score for the revised essay,
accessing a data set of candidate comments and selecting, from the data set based on at least the impact value, a comment that is associated with an essay or score type,
generating a revised electronic document file that includes a text representation of the candidate essay, along with the selected comment in association with the identified text span, and
causing a document presentation device to output the candidate essay with the selected comment in association with the identified text span.

2. The method of claim 1, further comprising, by the document presentation device, outputting the candidate essay with a comment that corresponds to the selected feedback in association with the identified text span

3. The method of claim 1, wherein:
analyzing the candidate essay and generating the score for the candidate essay comprises:
extracting a set of feature values from the candidate essay,
accessing a scoring model that includes probabilities that various feature values will be associated with various human-generated scores for a set of additional essays, wherein the candidate essay and each of the additional essays are responsive to a common prompt, and
applying the scoring model to the feature values extracted from the candidate essay to determine the score for the candidate essay; and
analyzing the revised essay and generating the score for the revised essay comprises:
extracting a set of feature values from the revised essay, and
applying the scoring model to the feature values extracted from the revised essay to determine the score for the revised essay.

4. The method of claim 1, in which parsing the electronic document file to identify and extract the text spans in the candidate essay comprises:
processing the candidate essay to identify one or more sequences of characters that correspond to the structure of a single sentence; and
identifying each text span so that each text span is a single sentence of the candidate essay.

5. The method of claim 1, wherein selecting the comment comprises selecting, from the data set, a comment that is tagged with a value that corresponds to the determined impact value.

6. The method of claim 1, wherein selecting the comment comprises:
identifying a set of candidate comments that correspond to a type of the essay;
applying one or more rules to filter the set of candidate comments; and
selecting the comment from the candidate comments that remain after the filtering.

7. The method of claim 1, in which generating the revised electronic document file that includes the text representation of the candidate essay along with the selected comment comprises:
identifying a set of candidate comments that correspond to a type of the essay;
generating a priority value for each of the candidate comments; and
automatically populating a comment box with those candidate comments whose priority value is at least equal to a threshold value.

8. The method of claim 1, wherein causing the document presentation device to output the candidate essay with the comment comprises causing the comment to be displayed in the candidate essay as an annotation to the identified text span.

9. The method of claim 1, further comprising, by the processing device:
identifying a first descriptor for the essay and a second descriptor for the identified text span;
accessing, via a computer network, an essay library;
selecting, from the essay library, an essay having a descriptor that corresponds to the first descriptor;
identifying, within the selected essay, a replacement text span having a descriptor that corresponds to the second descriptor;
extracting the replacement text span from the essay library;
replacing the identified text span with the replacement text span; and
causing the document presentation device to output the candidate essay with the replacement text span presented in place of the identified text span.

10. The method of claim 1, further comprising, by the processing device:
performing an automated transformation process on the identified text span to yield a mutated text span by replacing one or more words in the identified text spans with a synonym, or by changing an order of clauses within the identified span;
analyzing the essay with the mutated text span and generating a second score for the revised essay with the mutated text span; and
determining whether the mutated text span has a positive or negative impact on the score of the essay.

11. A system generating localized feedback for an electronic representation of an essay comprising:
a processing device;
a document presentation device;
a memory device in communication with the processing device via a communications network, the memory device containing a data set of candidate comments, each of which includes metadata for use in a selection process; and
a memory device containing programming instructions that are configured to, when executed, cause the processing device to:
receive an electronic document file, the file comprising an electronic representation of text from a candidate essay for evaluation;
process the electronic document file to analyze the candidate essay and generate a score for the candidate essay;
parse the electronic document file to identify and extract a plurality of text spans in the candidate essay; and
for at least one of the identified text spans:
generate a revised essay that omits the identified text span,
analyze the revised essay and generating a score for the revised essay,
determine an impact value for the identified text span so that the impact value comprises a measure of difference between the score for the candidate essay and the score for the revised essay,
access the data set of candidate comments and select, from the data set based on at least the impact value, a comment having metadata that is associated with an essay or score type,
generate a revised electronic document file that includes a text representation of the candidate essay, along with the selected comment in association with the identified text span, and
cause the document presentation device to output the candidate essay with the selected comment in association with the identified text span.

12. The system of claim 11, wherein:
the instructions to analyze the candidate essay and generate the score for the candidate essay comprise instructions to:
extract a set of feature values from the candidate essay,
access a scoring model that includes probabilities that various feature values will be associated with various human-generated scores for a set of additional essays, wherein the candidate essay and each of the additional essays are responsive to a common prompt, and
apply the scoring model to the feature values extracted from the candidate essay to determine the score for the candidate essay; and
the instructions to analyze the revised essay and generating the score for the revised essay comprise instructions to:
extract a set of feature values from the revised essay, and
apply the scoring model to the feature values extracted from the revised essay to determine the score for the revised essay.

13. The system of claim 11, wherein the instructions to parse the electronic document file to identify and extract the text spans in the candidate essay comprise instructions to:
process the candidate essay to identify one or more sequences of characters that correspond to the structure of a single sentence; and
identify each text span so that each text span is a single sentence of the candidate essay.

14. The system of claim 11, wherein the instructions to select the comment comprise instructions to select, from the data set, a comment that is tagged with a value that corresponds to the determined impact value.

15. The system of claim 11, wherein the instructions to select the comment comprise instructions to:
identify a set of candidate comments that correspond to a type of the essay;
apply one or more rules to filter the set of candidate comments; and
select the comment from the candidate comments that remain after the filtering.

16. The system of claim 11, in which the instructions to generate the revised electronic document file that includes the text representation of the candidate essay along with the selected comment comprise instructions to:
identify a set of candidate comments that correspond to a type of the essay;
generate a priority value for each of the candidate comments; and
automatically populate a comment box with those candidate comments whose priority value is at least equal to a threshold value.

17. The system of claim 11, wherein the instructions to cause the document presentation device to output the candidate essay with the comment comprise instructions to cause the comment to be displayed in the candidate essay as an annotation to the identified text span.

18. The system of claim 11, further comprising additional instructions that are configured to cause the processing device to:
identify a first descriptor for the essay and a second descriptor for the identified text span;
access, via a computer network, an essay library;
select, from the essay library, an essay having a descriptor that corresponds to the first descriptor;
identify, within the selected essay, a replacement text span having a descriptor that corresponds to the second descriptor;
extract the replacement text span from the essay library;
replace the identified text span with the replacement text span; and
cause the document presentation device to output the candidate essay with the replacement text span presented in place of the identified text span.

19. The system of claim 11, further comprising instructions that are configured to cause the processing device to:
perform an automated transformation process on the identified text span to yield a mutated text span by replacing one or more words in the identified text spans with a synonym, or by changing an order of clauses within the identified span;
analyze the essay with the mutated text span and generate a second score for the revised essay with the mutated text span; and
determine whether the mutated text span has a positive or negative impact on the score of the essay.
